(19) United States
(12) Patent Application Publication
(10) Pub. No.: US 2018/0304783 A1
(43) Pub. Date: Oct. 25, 2018

(54) COVER AND METHOD FOR PRODUCING A COVER

(71) Applicant: Adient Luxembourg Holding S.à r.l., Luxembourg (LU)

(72) Inventor: Davi DI GRAZIA, Santo Andre - SP (BR)

(21) Appl. No.: 15/771,748

(22) PCT Filed: Oct. 11, 2016
(86) PCT No.: PCT/EP2016/074326

§ 371 Date: Apr. 27, 2018

Related U.S. Application Data
(60) Provisional application No. 62/248,649, filed on Oct. 30, 2015.

(51) Int. Cl. B60N 2/58; B60N 2/75; B32B 5/02; B32B 5/18; B32B 5/24; B32B 7/02; B32B 5/26; B32B 27/12; B32B 27/06; B32B 37/24; B29C 70/68

(52) U.S. Cl. CPC B60N 2/5891; B60N 2/75; B32B 5/022; B32B 5/024; B32B 5/18; B32B 5/245; B60N 2/80; B32B 5/028; B32B 5/26; B32B 27/12; B32B 27/065; B32B 37/24; B29C 70/68; B32B 7/02

(57) ABSTRACT

The present invention provides a cover (2) for an interior component of a vehicle comprising: —an exterior cover element (2.1) and —a back coating (B) formed at least as a back barrier (2.2) bonded to the exterior cover element (2.1), wherein —the back barrier (2.2) is formed by a plastic fibres material. The present invention further provides a process for the production of a pour-in-place formed cover (2) and an armrest (3) comprising such a cover (2).

### BACKGROUND OF THE INVENTION

The present invention relates to a cover and to a method producing a cover.

Most furniture and automotive vehicle seats, in particular seat parts like seat portions and backrest, armrests and headrests are usually produced from moulded foam, e.g. polyurethane foam cushions or parts. Subsequent to the foam moulding process, the part is wrapped in pre-cut and pre-sewn fabric covers.

Alternatively, the seat parts are produced by a so called “pour-in-place” method (also called foam-in-fabric or foam-in-cover method). The pour-in-place method involves pouring polyurethane foam reactants in a liquid form onto a pre-shaped cover and then allowing the foam to expand and cure to form an in-situ foamed moulded part.

### SUMMARY OF THE PRESENT INVENTION

It is an object of the present invention to provide a cover for an interior component of a vehicle with an improved soft-touch surface.

The object is achieved by a cover according to claim 1 and by a method for producing such a cover according to claim 8.

According to the invention, a cover for an interior component of a vehicle comprises an exterior cover element and a back barrier bonded to the cover element, wherein the back barrier is formed by a non-woven plastic fibres material. The non-woven plastic fibres material is made from plastic raw fibres which are randomly arranged.

Using a non-woven plastic fibres material as a back barrier for the exterior cover element allows an improved soft touch and good feeling to the user. Furthermore, such a cover comprising non-woven plastic fibres material is about 15% cheaper than the known sew trim cover. Further, hard spot and orange peel of the cover are reduced in comparison to known cover.

The interior component is e.g. a headrest or an armrest. The cover is a headrest trim cover or an armrest trim cover.

The cover element is formed as a foil or vinyl and made from a plastic, e.g. polyvinylchloride (shortly called PVC or PVC vinyl), namely artificial leather, or a fabric, namely a textile fabric. Alternatively, the plastic cover element is made from thermoplastic polyurethane (shortly called TPU or TPU vinyl), polyolefin-elastomer (shortly called TPO or TPO vinyl) or polyurethane (shortly called PU or PU vinyl).

According to an embodiment, the back barrier is made from a non-woven plastic fibres material with a weight per a given unit area between 30 g/m2 to 350 g/m2.

In a further embodiment, the back barrier is directly bonded to the cover element and formed by a non-woven plastic fibres material with a weight per a given unit area between 50 g/m² to 350 g/m². The weight is measured for a fibres layer of a 1 m×1 m unit using a conventional measuring device, e.g. an electronic balance or weighing machine.

In an alternative embodiment, the cover further comprises a support layer bonded to the exterior cover element and a foam layer bonded to the support layer, wherein the back barrier is bonded to the foam layer.

The support layer is a back net for the cover element and provides sewing resistance for the cover element. The support layer can be formed by a fabric, e.g. cotton, or by plastic fibres, e.g. polyester fibres (PES), polyethylen-terephthalat fibres (PET) or polyamide fibres (PA). The fibres are knit, woven or warped.

The foam layer is a lamination and made from a polyurethane foam (PU foam) and provides the soft touch feeling for the final cover. Optionally, a glue is provided between the foam layer and the back barrier to stick them. The glue may be on the base of a polyurethane adhesive or an acrylic adhesive.

According to this alternative embodiment, the back barrier is formed by a non-woven plastic fibres material with a weight per a given unit area between 30 g/m² to 150 g/m². Further, the foam layer is formed by foam with a density of greater than 15 kg/m³. More specifically, this alternative embodiment is directed to a cover having an exterior cover element and a foam core, preferably a polyurethane foam core, more preferably a flexible polyurethane foam core, with a non-woven back barrier by the pour-in-place technique.

The invention is further directed to an improved process for the production of a cover, in particular a pour-in-place cover having at least an exterior cover element and a back barrier, wherein a shaped mould for the pour-in-place technique is provided, wherein the exterior cover element is positioned in a shaped mould, the shaped mould is being closed, a non-woven plastic fibres material, in particular plastic fibres material is applied to the shaped mould to fully react to form the back barrier and to bond it to the exterior cover element, thereby forming the cover. Subsequently, the formed cover is removed from the shaped mould.

The invention further features a cover for an interior component of a vehicle comprising an exterior cover element and a back coating formed at least as a back barrier bonded to the cover element, wherein the back barrier is formed by a woven, in particular hydrophobic, plastic fibres material. Such a back coating formed by woven plastic fibres materials with high surface tension brings advantages when compared to known lamination solutions.

The concept of the invention is to use hydrophobic or water-repellent materials as a back layer in the composition of substrates like fabrics, vinyl or leathers for forming a new poured cover. By adding laminated foam onto the substrates before applying the hydrophobic materials a new cover is formed that will be cut and sewed to produce a trim cover that will be poured with e.g. foam material or other chemistry to mould a headrest or an armrest.

Current known layers of substrates as back coating for a cover have control of air permeability which intention is to minimize defects like “hard sports” and “orange peel” defects. The property “air permeability” cannot prevent “absorption” of chemistry by the substrate since the chemistry is liquid on initial state of pouring process, and depending on the surface tension of the layers of substrate, the result is not enough to avoid the “capillary” penetration of chemistry resulting in non-conforming parts and rejections. Using of a hydrophobic or water-repellent materials as a back layer of the back coating or substrate provides a barrier which avoids these undesired side effects because the back barrier will not allow the liquid material to penetrate inside laminated foam cells of the back coating and the cover element.

In other words: The hydrophobic material (similar those used to form a diapers or medical masks) as a back barrier is used against flow or migration of fluid material used to formulate pouring material that normally is a blend of isocianate and poliol plus additives, e.g. polyurethane.

In a possible embodiment the back coating is configured as a multi-layer coating. In particular, the back coating is bonded to the exterior cover element.

In another embodiment, the back barrier is made from a non-woven plastic fibres material with a weight per a given unit area between 10 g/m² to 350 g/m², in particular 30 g/m² to 350 g/m² or 50 g/m² to 350 g/m².

In certain embodiments, the back barrier is made from a woven plastic fibres material with a weight per a given unit area between 10 g/m² to 70 g/m². This woven material is responsible to be the barrier against the pouring material migration.

In further embodiments, the back barrier is made from a hydrophobic plastic material, in particular from at least one of polypropylene, polyurethane and polyamide or a blend of isocianate and poliol plus additives. The a woven material must be produced to have “high surface tension” in order to be “hydrophobic”.

In some embodiments, the back barrier is made from a plastic material having a high surface tension of higher 800 mm water column, in particular of 1,500 mm water column. The high surface tension rates are defined and described in DIN ISO 9073-16.

The back barrier is bonded on laminated foam by heating, in particular by a “flame” process, fusing or gluing.

In a possible embodiment the cover comprises the back coating formed by a set of layers, wherein the support layer is bonded to the exterior cover element and the back barrier is bonded to the support layer. Additionally, the back coating may further comprise a foam layer, wherein the support layer is bonded to the exterior cover element, the foam layer is bonded to the support layer, and the back barrier is bonded to the foam layer.

In a further embodiment, the foam layer may be formed by a foam with a density of greater than 15 kg/m³. The foam layer has a low density and allows a good feeling of the final product, e.g. an armrest or headrest. The density can be modified according to customer needs. The foam layer is bonded to the backing net or support layer of the substrate (vinyl, leather or fabric) by e.g. a “flame” process or “glued”.

The exterior cover element is made from a plastic or a fabric. In particular, the exterior cover element may be formed as mentioned above as a foil, vinyl, an artificial leather, or a fabric, namely a textile fabric.

According to a further embodiment, each layer of the back coating differs in at least one diffusion barrier property from the other layer in the back coating. Furthermore, the back coating conforms to and sealingly engages the exterior cover element.

The invention is further directed to an improved process for the production of a pour-in-place formed cover having at least an exterior cover element and a back coating, wherein the back coating is applied as a back barrier, wherein a shaped mould for the pour-in-place technique is provided, the exterior cover element is positioned in the shaped mould, the shaped mould is being closed, a plastic fibres material is applied to the shaped mould to fully react to form the back barrier and to bond it to the exterior cover element, thereby forming the cover, wherein subsequently, the formed cover is removed from the shaped mould.

According to another process for the production of a pour-in-place formed cover having at least an exterior cover element and a back coating, the back coating is applied in at least one set of layers, wherein a shaped mould for the pour-in-place technique is provided, wherein the exterior cover element is positioned in the shaped mould, a support layer is applied onto the exterior cover element, the shaped mould is being closed, a plastic fibres material is applied to the shaped mould to fully react to form the back barrier and to bond it to the support layer thereby forming the cover, wherein subsequently, the formed cover is removed from the shaped mould.

According to a further process for the production of a pour-in-place formed cover having at least an exterior cover element and a back coating, the back coating is applied in at least one set of layers, wherein a shaped mould for the pour-in-place technique is provided, wherein the exterior cover element is positioned in the shaped mould, a support layer is applied onto the exterior cover element, the shaped mould is being closed, foam layer is applied to the shaped mould to bond it to the support layer, a plastic fibres material is applied to the shaped mould to fully react to form the back barrier and to bond it to the foam layer, thereby forming the cover, wherein subsequently, the formed cover is removed from the shaped mould.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limitative of the present invention, and wherein:

FIG. 1 shows a schematic view of a mould for forming a cover,

FIG. 2 shows a schematic view of a cover made from a cover element and a thin layer of a back barrier,

FIG. 3 shows a schematic view of an alternative cover made from a cover element and a thin foam layer with a bonded thin layer of a back barrier,

FIG. 4 shows a schematic view of another alternative cover made from a cover element, a support layer, a thin foam layer with a bonded thin layer of a back barrier and

FIG. 5 shows a schematic view of the cover made from the cover element and a thin layer of the back barrier according to FIG. 2,

FIGS. 6 to 8 show schematic views of a cover made from the cover element and an alternative back coating configured as a multi-layer coating with at least one hydrophobic plastic layer,

FIG. 9 shows a perspective view of an armrest with a cover, and

FIG. 10 shows a perspective view of a headrest with a cover.

Corresponding parts are marked with the same reference symbols in all figures.

### DETAILED DESCRIPTION OF PREFERRED EMBODIMENTS

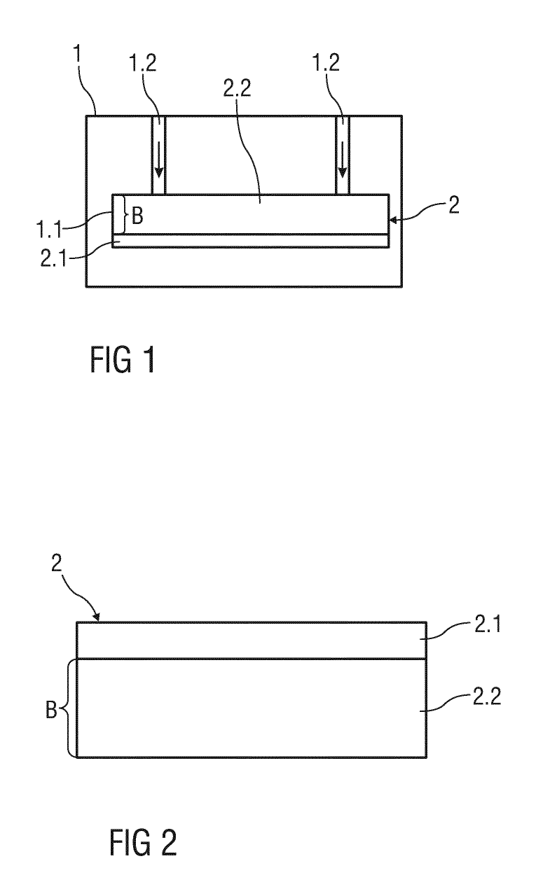

FIG. 1 shows a mould 1 for producing a cover 2 by a so-called pour-in-place method (PIP method).

The mould 1 comprises at least a shaped cavity 1.1 to form the cover 2 and inlets 1.2 for applying raw material for forming the cover 2 in the cavity 1.1.

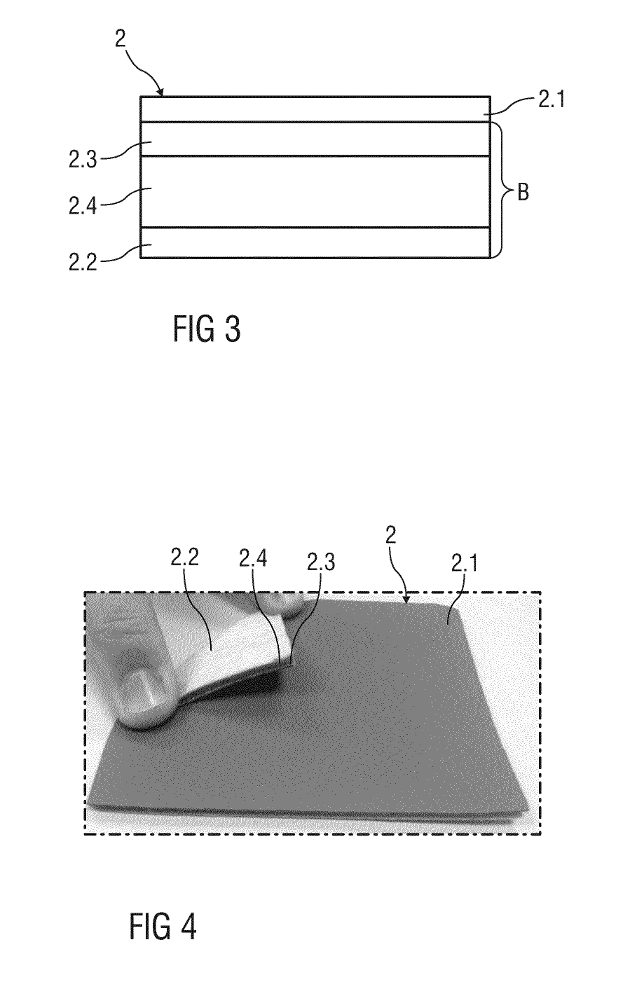

The cover 2 comprises at least an exterior cover element 2.1 which can be a fabric or a plastic backed by a back coating B. The back coating B is configured as a thin layer of a back barrier 2.2. Alternatively, the back coating B can be configured as a multi-layer coating shown in FIGS. 3, 6, 7.

The back barrier 2.2 is made of a non-woven or woven plastic fibres material, in particular non-woven or woven plastic raw fibres material. The back barrier 2.2 may include reinforcement fibres. In particular, the non-woven plastic fibres material is made from plastic raw fibres which are randomly arranged. The woven plastic fibres/fabrics are made from plastic raw fibres which are woven.

The exterior cover element 2.1 is made of a fabric, e.g. a textile fabric, or a plastic, e.g. a PVC vinyl, grained TPO or grained TPU, which is positioned into cavity 1.1.

Subsequently, the non-woven plastic fibres material of the back barrier 2.2 is applied by the inlets 1.2 into the cavity 1.1. Such a non-woven barrier material applied by the so-called PIP method allows an improved soft-touch surface of the cover 2 and is very cost-effective. Further, hard sport and orange peel of the cover 2 are reduced in comparison to a known cover.

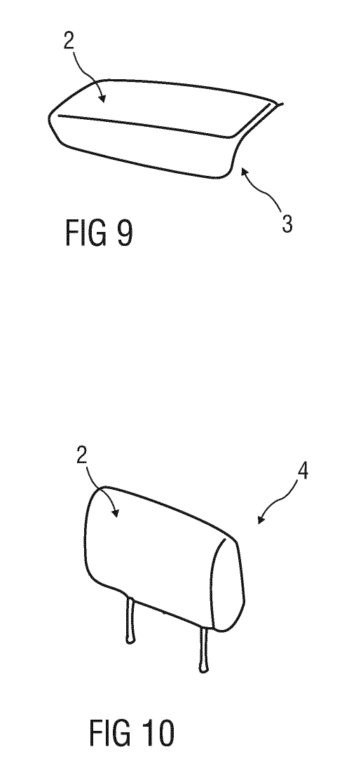

The cover 2 is e.g. made for a not further shown interior component of a vehicle, wherein the interior component is e.g. a headrest or an armrest 3 (see FIG. 9). The cover 2 is a headrest trim cover or an armrest trim cover.

In detail the exterior cover element 2.1 is positioned in the shaped cavity 1.1 of the mould 1. After positioning of the exterior cover element 2.1 in the shaped cavity 1.1 the mould 1 is being closed to keep the exterior cover element 2.1 in position.

The PIP method involves pouring the non-woven or woven plastic fibres material of the back barrier 2.2 in a liquid form through the inlets 1.2 of the mould 1 into the shaped cavity 1.1. The non-woven or woven fibres plastic material is therefore applied to the shaped cavity 1.1 to fully react to form the back barrier 2.2 and to be bonded to the exterior cover element 2.1.

The non-woven or woven fibres plastic material is allowed by the PIP method to expand and cure to form an in-situ foamed cover 2.

Subsequently, the cover 2 can be removed as a whole part from the mould 1.

The back barrier 2.2 is made for example from a non-woven plastic fibres material with a weight per a given unit area between 10 g/m² to 350 g/m², in particular 30 g/m² to 350 g/m² or 50 g/m² to 350 g/m². Additionally or alternatively, the back barrier 2.2 is made from a woven plastic fibres material with a weight per a given unit area between 10 g/m² to 70 g/m².

Furthermore, the back barrier 2.2 is made from a hydrophobic plastic material, in particular from at least one of polypropylene, polyurethane and polyamid. For example, the back barrier 2.2 is made from a plastic material having a high surface tension of higher 800 mm water column, in particular of 1,500 mm water column.

FIG. 2 shows the cover 2 made from the exterior cover element 2.1 and the thin layer of the back barrier 2.2 after the PIP forming method.

The cover element 2.1 is formed as a foil or artificial leather. Alternatively, the cover element 2.1, especially the plastic cover element 2.1, is made from thermoplastic polyurethane, e.g. a TPU vinyl, a TPO vinyl or a PU vinyl.

The cover 2 comprises a comparatively high stability and in particular a light weight. The back barrier 2.2 comprises a weight per a given unit area between 30 g/m² to 350 g/m².

It is possible that the back barrier 2.2 is bonded to the cover element 2.1 by a heating or a laminating method or by a gluing process.

The cover 2 according to this embodiment comprises the exterior cover element 2.1 of a thickness between 0.3 mm to 2 mm, in particular 0.5 mm to 1.2 mm and the back barrier 2.2 of a thickness between 0.2 mm to 6 mm, particularly 0.5 mm to 5 mm.

FIG. 3 shows an alternative cover 2 comprising the cover element 2.1 and the thin layer of the back barrier 2.2.

The cover element 2.1 comprises a thickness between 0.3 mm to 2 mm, in particular 0.5 mm to 1.2 mm.

In the shown embodiment of the cover 2 a thin support layer 2.3 of a thickness between 0.1 mm to 1 mm, in particular 0.1 mm to 0.5 mm, is arranged at an inner side of the cover element 2.1 and is bonded to the cover element 2.1. The cover element 2.1 is backed by the support layer 2.3 made from plastic, cotton or a similar material.

Another thin foam layer 2.4 of a thickness between 1.5 mm to 7 mm, especially 2 mm to 6 mm, is arranged between the support layer 2.3 and the bonded thin layer of the back barrier 2.2. The thin foam layer 2.4 is e.g. a lamination foam which is bonded to the support layer 2.3 and the back barrier 2.2 by a heating method or a gluing process.

Further, the cover 2 can be produced by the PIP method, wherein the different layers are applied layer by layer in the mould 1.

This arrangement increases a mechanical strength or rigidity e.g. due to customer needs. Furthermore, the foam layer 2.4 is formed by foam with a density of greater than 15 kg/m3.

To reduce the weight of the cover 2 comprising the support layer 2.3 and the foam layer 2.4 the back barrier 2.2 can be formed of a thickness between 0.1 mm to 1.5 mm, in particular 0.1 mm to 1 mm, by a non-woven plastic fibres material with a weight per a given unit area between 30 g/m² to 150 g/m2.

More specifically, this alternative embodiment is directed to the cover 2 having the exterior cover element 2.1 and a foam core, preferably a polyurethane foam core, more preferably a flexible polyurethane foam core

FIG. 4 shows another alternative cover 2 comprising the cover element 2.1 and the thin layer of the back barrier 2.2.

The cover element 2.1 is a surface layer which is visible to a customer. Further, the cover element 2.1 can be made from grained PVC, grained TPO, grained TPU or fabric. To support the cover element 2.1 the support layer 2.3 is bonded to the cover element 2.1. In this embodiment the support layer 2.3 can be formed as a back barrier or a so called back net of the cover element 2.1.

The support layer 2.3 is made from plastic, e.g. polypropylene (shortly called PP), cotton, polyester (shortly called PES), polyethylene terephthalate (shortly called PET), polyamide (shorty called PA) or from another material. A purpose of the support layer 2.3 is to provide sewing resistance to the cover element 2.1 and control of an elongation of the material in roll and cross direction of the cover element 2.1 of the cover 2. Further, the support layer 2.3 is made by knitting, weaving, wrapping and/or another similar method.

The foam layer 2.4 can be laminated foam formed by foam with a density of greater than 18 kg/m3. This foam layer 2.4 is bonded to the support layer 2.3, wherein the density of the foam layer 2.3 is related to a good feeling, e.g. soft touch to the user as a final product and can be modified according to customer needs.

Furthermore, the back barrier 2.2 is bonded to the foam layer 2.3, wherein the back barrier 2.2 is made from a non-woven plastic fibres material with a weight per a given unit area between 30 g/m2 to 350 g/m2. The non-woven plastic fibres material is provided to repel pouring material migration.

In another embodiment of the cover 2 a not shown full coat is bonded between the foam layer 2.4 and the back barrier 2.2. The full coat is e.g. made of a thickness between 0.1 mm to 0.7 mm, particularly 0.1 mm to 0.3 mm, from thermoplastic polyurethane, polyolefin-elastomer or another polyurethane material. Alternatively or additional a not shown glue or adhesive layer of a thickness between 0.1 mm to 0.3 mm is arranged between the foam layer 2.4 and the back barrier 2.2. Therefore, the foam layer 2.4 and the back barrier 2.2 can be bonded together, e.g. by a heating, gluing and/or lamination process. The glue layer is made from thermoplastic polyurethane, polyolefin-elastomer, polyurethane or acrylic material.

FIG. 5 shows the cover 2 made from the cover element 2.1 and the thin layer of the back barrier 2.2 according to FIG. 2.

The back barrier is directly bonded to the cover element 2.1 and formed by a non-woven plastic fibres material with a weight per a given unit area between 50 g/m² to 350 g/m².

More specifically, this embodiment is directed to the cover 2 which is cheaper than the known sew trim cover, e.g. due to minimization of scrap. Further, the scrap is related to hard spot and orange peel of the cover 2 which are also reduced in comparison to known cover.

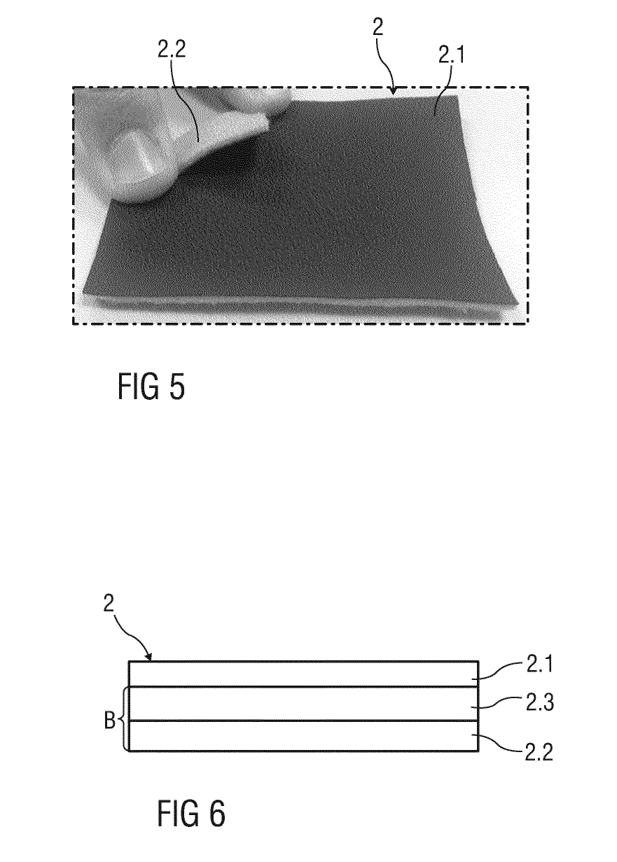

FIGS. 6 to 8 show schematic views of a further cover 2 made from a cover element 2.1 and an alternative back coating B configured as a multi-layer coating with at least one hydrophobic plastic layer.

FIG. 6 shows another cover 2 comprising an exterior cover element 2.1 with a back coating B having a support layer 2.3 bonded to the exterior cover element 2.1 and a back barrier 2.2 bonded to the foam layer 2.4.

Optionally, the back coating B may further comprise a foam layer 2.4 arranged between the support layer 2.3 and the back barrier 2.2 and bonded to the support layer 2.3 (see also FIG. 3).

The back barrier 2.2 is made from a woven plastic fibres material with a weight per a given unit area between 10 g/m² to 70 g/m². In particular, the back barrier 2.2 is made from a hydrophobic plastic material, in particular from at least one of polypropylene, polyurethane and polyamid. For example, the back barrier 2.2 is made from a plastic material having a high surface tension of higher 800 mm water column, in particular of 1,500 mm water column.

The foam layer 2.4 is formed by foam with a density of greater than 15 kg/m³.

According to a further aspect of the invention, each layer 2.2 to 2.3 or 2.2 to 2.4 of the back coating B differs in at least one diffusion barrier property from the other layer 2.2 to 2.4 in the back coating B. In particular, the layers 2.2 to 2.4 differ in their high surface tension parameters. Furthermore, the back coating B conforms to and sealingly engages the exterior cover element 2.1. Further, the mould 1 comprises a shape to form the exterior cover element 2.1.

Referring to the process for the production of the pour-in-place formed cover 2 having at least an exterior cover element 2.1 and a multi-layer back coating B, the multi-layer back coating B is applied in at least one set of layers 2.2 to 2.3 or 2.2 to 2.4, wherein the shaped mould 1 (shown for example in FIG. 1) for the pour-in-place technique is provided, wherein the exterior cover element 2.1 is positioned in the shaped mould 1, the support layer 2.3 is applied onto the exterior cover element 2.1, the shaped mould 1 is being closed, a plastic fibres material is applied to the shaped mould 1 to fully react to form the back barrier 2.2 and to bond it to the support layer 2.3 thereby forming the cover 2, wherein subsequently, the formed cover 2 is removed from the shaped mould 1.

Optionally, after the shaped mould 1 is being closed, the foam layer 2.4 may be applied to the shaped mould 1 to bond it to the support layer 2.2 and, subsequently, the plastic fibres material is applied to the shaped mould 1 to fully react to form the back barrier 2.2 and to bond it to the foam layer 2.4, thereby forming the cover 2, wherein, subsequently, the formed cover 2 is removed from the shaped mould 1.

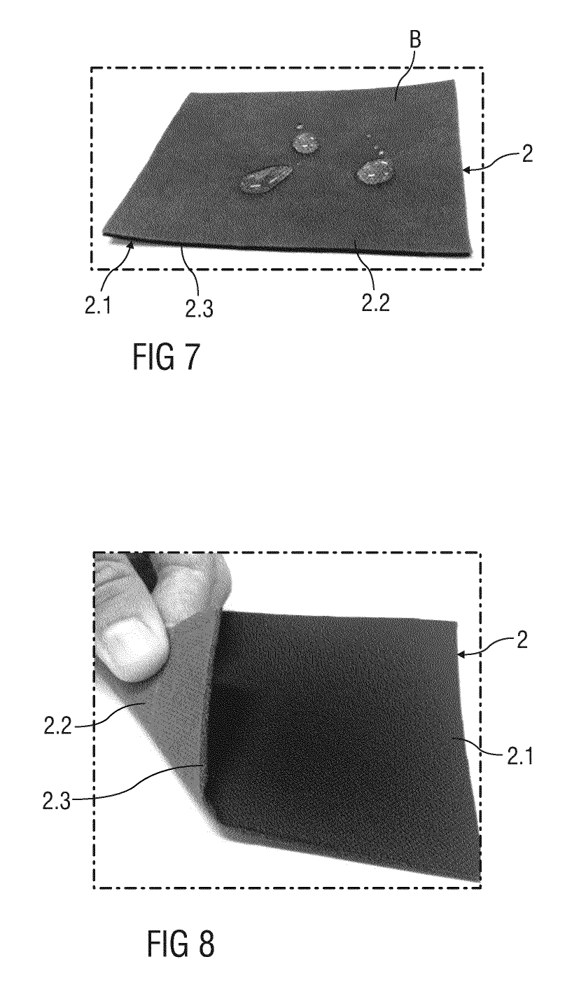

FIGS. 7 and 8 shows the cover 2 made from the cover element 2.1, the support layer 2.3 and the thin layer of the back barrier 2.2 which is configured as a hydrophobic layer. The back barrier 2.2 is arranged on the back side of the cover 2. The exterior cover element 2.1 is arranged on the front side of the cover 2.

FIG. 9 shows an armrest 3 comprising a cover 2 described above.

FIG. 10 shows a headrest 4 comprising a cover 2 described above.

### LIST OF REFERENCES

1 mould
1.1 cavity
1.2 inlet
2 cover
2.1 cover element
2.2 back barrier
2.3 support layer
2.4 foam layer
3 armrest
4 headrest
B back coating

1. A cover for an interior component of a vehicle, the cover comprising:
an exterior cover element; and
a back coating formed at least as a back barrier bonded to the exterior cover element, wherein the back barrier is formed by a plastic fibers material.

2. The cover according to claim 1, wherein the back coating is configured as a multi-layer coating.

3. The cover according to claim 1, wherein the plastic fibers material of the back barrier is made from a non-woven plastic fibers material with a weight per a given unit area between 10 g/m² to 350 g/m².

4. The cover according to claim 1, wherein the plastic fibers material of the back barrier is made from a woven plastic fibers material with a weight per a given unit area between 10 g/m² to 70 g/m².

5. The cover according to claim 1, wherein the plastic fibers material of the back barrier is made from a hydrophobic plastic material comprising at least one of polypropylene, polyurethane and polyamid.

6. The cover according to claim 1, wherein the plastic fibers material of the back barrier is made from a plastic material having a high surface tension of higher 800 mm water column.

7. The cover according to claim 1, wherein:
the back coating further comprises a support layer;
the support layer is bonded to the exterior cover element; and
the back barrier is bonded to the support layer.

8. The cover according to claim 5, wherein:
the back coating further comprises a foam layer and a support layer;
the support layer is bonded to the exterior cover element;
the foam layer is bonded to the support layer and
the back barrier is bonded to the foam layer.

9. A cover according to claim 6, wherein the foam layer is formed by a foam with a density of greater than 15 kg/m³.

10. A cover according to claim 1, wherein the exterior cover element is made from a plastic or a fabric.

11. The cover according to claim 2, wherein each layer of the back coating differs in at least one diffusion barrier property from the other layer in the back coating.

12. The cover according to claim 1, wherein the back coating conforms to and sealingly engages the exterior cover element.

13. A process for the production of a pour-in-place formed cover having at least an exterior cover element and a back coating, wherein the back coating is applied as a back barrier; the process comprising the steps of:
providing a shaped mold for the pour-in-place technique;
positioning the exterior cover element in the shaped mold;
closing the shaped mold;
applying a plastic fibers material to the shaped mold to fully react to form the back barrier and to bond the back barrier to the exterior cover element, thereby forming the cover; and
subsequent to said step of applying, removing the formed cover from the shaped mold.

14. A process for the production of a pour-in-place formed cover having at least an exterior cover element and a back coating, wherein the back coating is applied in at least one set of layers (2.2 to 2.3), the process comprising the steps of:
providing a shaped mold for the pour-in-place technique;
positioning the exterior cover element in the shaped mold;
applying a support layer onto the exterior cover element;
closing the shaped mold;
applying a plastic fibers material to the shaped mold to fully react to form the back barrier and to bond the back barrier to the support layer thereby forming the cover;
subsequent to said step of applying, removing the formed cover from the shaped mold.

15. A process for the production of a pour-in-place formed cover having at least an exterior cover element and a back coating, wherein the back coating is applied in at least one set of layers (2.2 to 2.3), the process comprising the steps of:
providing a shaped mould (1) for the pour-in-place technique;
positioning the exterior cover element in the shaped mold;
applying a support layer onto the exterior cover element;
closing the shaped mold;
applying a foam layer to the shaped mold to bond the foam layer to the support layer;
applying a plastic fibers material to the shaped mold to fully react to form the back barrier and to bond the back barrier to the foam layer, thereby forming the cover; and
subsequent to applying the plastic fibers material, the formed cover is removed from the shaped mold.

16. An armrest comprising a cover comprising:
an exterior cover element; and
a back coating formed at least as a back barrier bonded to the exterior cover element, wherein the back barrier is formed by a plastic fibers material.

17. The armrest according to claim 16, wherein the back coating comprises a multi-layer coating.

18. The armrest according to claim 16, wherein the plastic fibers material of the back barrier is made from a non-woven plastic fibers material with a weight per a given unit area between 10 g/m² to 350 g/m².

19. The armrest according to claim 16, wherein the plastic fibers material of the back barrier is made from a woven plastic fibers material with a weight per a given unit area between 10 g/m² to 70 g/m².

20. The armrest according to claim 16, wherein the plastic fibers material of the back barrier is made from a hydrophobic plastic material comprising at least one of polypropylene, polyurethane and polyamid.
